(19) United States
(12) Patent Application Publication
(10) Pub. No.: US 2020/0370830 A1
(43) Pub. Date: Nov. 26, 2020

(54) SYSTEM AND METHOD FOR DRYING ORGANIC MATERIALS

(71) Applicant: DESEREST CORPORATION, Hagerstown, MD (US)

(72) Inventors: Michael Joseph Purdon, Coffeyville, KS (US); Hassan Ali Zarrabi, Las Vegas, NV (US)

(21) Appl. No.: 16/969,160

(22) PCT Filed: Feb. 12, 2019
(86) PCT No.: PCT/US2019/017618

§ 371 Date: Aug. 11, 2020

Related U.S. Application Data
(60) Provisional application No. 62/630,157, filed on Feb. 13, 2018.

(51) Int. Cl. F26B 25/22; F26B 21/08; F26B 21/10; F26B 21/12; F26B 21/14; F26B 3/04; F26B 9/06; F26B 21/02

(52) U.S. Cl. CPC F26B 25/225; F26B 21/08; F26B 21/10; F26B 21/12; F26B 2200/00; F26B 3/04; F26B 9/066; F26B 21/028; F26B 21/14

(57) ABSTRACT

A system for drying an organic material includes: a drying chamber to hold the organic material under controlled atmospheric conditions; convection equipment to regulate temperature and humidity within the drying chamber; flow control equipment to regulate flow of one or more gases in and out of the drying chamber; sensing equipment to sense the atmospheric conditions of the drying chamber; a processor; and memory communicably connected to the processor. The memory stores instructions that, when executed by the processor, cause the processor to: receive sensed data from the sensing equipment; and control the convection equipment and the flow control equipment based on the sensed data.

### CROSS-REFERENCE TO RELATED APPLICATIONS

This application claims priority to and benefit of U.S. Provisional Application No. 62/630,157, filed on Feb. 13, 2018, which is incorporated herein by reference in its entirety.

### TECHNICAL FIELD

The present invention relates generally to systems and methods for drying organic materials. The present invention relates more particularly to systems and methods for drying organic materials under controlled atmospheric conditions to reduce moisture and unwanted elements on the organic materials, and to preserve organoleptic and other properties of the organic materials.

### BACKGROUND

Organic materials are any kind of materials that are found in nature or are made out of materials that are found in nature. Examples of organic materials include, for example, wood, paper, textiles, plants, animal parts, and the like. Organic materials may include organic compounds, which contain the element carbon. Some organic materials may be ingested as food, such as meat from animals, or herbs that may be used as medicines, flavoring, aromatic compounds, and/or the like.

One such example of a plant organic material is the cannabis plant, which can be used medicinally, therapeutically, and/or recreationally. The cannabis plant contains various chemical compounds called cannabinoids that activate cannabinoid receptors on cells that repress neurotransmitter release in the brain.

Living cannabis may contain about 80% water. Most methods currently utilized to dry cannabis plants are characterized by a slow drying time, which may be suitable for preserving the plant's properties. For example, screen drying involves spreading cannabis plants out on screens to dry. The screens can be laid out or placed in a dehydrator. Some drawbacks to screen drying include extra labor in removing leaves from buds and removing buds from the stems. Screen drying may also produce uneven drying, resulting in some parts of the cannabis plant drying faster than other parts of the cannabis plant.

Another example method of slow drying uses a drying line, wherein colas, branches, or entire plants may be hung upside down from wire or rope lines running from wall to wall. This makes a convenient temporary hanging system, but as the bud dries, the water in the stem can slowly wick into the bud, which can slow down the drying process. Another method of slow drying is cage drying, wherein buds can be hung from wire cages. Because the cages can be picked up and moved, they can easily be moved closer to or further from heaters, fans and dehumidifiers for more even drying.

Some faster methods of the drying process may include the use of fans, heaters, and/or dehumidifiers. However, while these methods can be more convenient and more adaptable at industrial scales, these faster drying methods may damage various properties of the cannabis, such as, for example, cannabinoids, terpenes, and/or flavonoids.

Thus, systems and methods that enable sufficiently fast drying of organic materials, for example, such as animal and/or plant organic materials, while preserving organoleptic, medicinal, and other properties of the organic materials may be desired.

The above information disclosed in this Background section is for enhancement of understanding of the background of the invention, and therefore, it may contain information that does not constitute prior art.

### SUMMARY

According to an example embodiment, a system for drying an organic material includes: a drying chamber configured to hold the organic material under controlled atmospheric conditions; convection equipment configured to regulate temperature and humidity within the drying chamber; flow control equipment configured to regulate flow of one or more gases in and out of the drying chamber; sensing equipment configured to sense the atmospheric conditions of the drying chamber; a processor; and memory communicably connected to the processor and storing instructions that, when executed by the processor, cause the processor to: receive sensed data from the sensing equipment; and control the convection equipment and the flow control equipment based on the sensed data.

In some embodiments, the flow control equipment may include a main flow valve, and a vacuum generating device; and the instructions may cause the processor to open the main flow valve and activate the vacuum generating device to remove air, humidity, and/or the one or more gases from the drying chamber to generate a vacuum in the drying chamber.

In some embodiments, the flow control equipment may include one or more gas valves configured to adjust a ratio of a gas mixture within the drying chamber, the gas mixture corresponding to a mixture of the one or more gases that preserves one or more properties of the organic material; and the instructions may further cause the processor to open the one or more gas valves to introduce the gas mixture into the drying chamber.

In some embodiments, the sensing equipment may include a temperature sensor, and a humidity sensor; and the instructions may further cause the processor to control the convection equipment to cycle through one or more activation and deactivation cycles based on the temperature detected by the temperature sensor and the humidity detected by the humidity sensor.

In some embodiments, the convection equipment may include a fan and a heating device; and the instructions may further cause the processor to: control the fan to reduce the humidity in the drying chamber in response to the humidity sensor detecting that a humidity level within the drying chamber exceeds a threshold humidity level; and control the heating device to increase the temperature in the drying chamber in response to the temperature sensor detecting that the temperature within the drying chamber decreases below a threshold temperature level.

In some embodiments, the sensing equipment may include one or more load cells configured to measure a mass of the organic material held within the drying chamber; the flow control equipment may include a purge valve; and the instructions may further cause the processor to control the purge valve to equalize a pressure within the drying chamber with an external pressure in response to the one or more load cells detecting that the mass of the organic material is decreased to a target level.

In some embodiments, the one or more load cells may be arranged below a product container configured to hold the organic material within the drying chamber.

In some embodiments, the one or more load cells may be arranged above a product container configured to hold the organic material within the drying chamber.

In some embodiments, the sensing equipment may include one or more moisture sensors configured to measure a moisture level in the organic material held within the drying chamber; the flow control equipment may include a purge valve; and the instructions may further cause the processor to control the purge valve to equalize a pressure within the drying chamber with an external pressure in response to the one or more moisture sensors detecting that the moisture level of the organic material is decreased to a target moisture level.

In some embodiments, the organic material may correspond to a portion of a plant.

According to another example embodiment, a method for drying an organic material includes: holding, within a drying chamber, the organic material under controlled atmospheric conditions; measuring, by sensing equipment, the atmospheric conditions within the drying chamber; regulating, by convection equipment, temperature and humidity within the drying chamber based on the measured atmospheric conditions; and regulating, by flow control equipment, flow of one or more gases in and out of the drying chamber based on the measured atmospheric conditions.

In some embodiments, the method may further include generating a vacuum in the drying chamber by: opening a main flow valve of the flow control equipment; and activating a vacuum generating device to generate the vacuum by removing air, humidity, and/or the one or more gases from the drying chamber through the main flow valve.

In some embodiments, the method may further include injecting one or more of the one or more gases into the drying chamber by opening one or more gas valves of the flow control equipment.

In some embodiments, the method may further include adjusting a ratio of a gas mixture within the drying chamber, the gas mixture corresponding to a mixture of the one or more gases that preserves one or more properties of the organic material.

In some embodiments, the method may further include: detecting, by a temperature sensor of the sensing equipment, a temperature within the drying chamber; detecting, by a humidity sensor of the sensing equipment, a humidity level within the drying chamber; and cycling through one or more activation and deactivation cycles, by the convection equipment, based on the temperature detected by the temperature sensor and the humidity detected by the humidity sensor.

In some embodiments, the method may further include: reducing, by a fan of the convection equipment, the humidity level in the drying chamber in response to the humidity sensor detecting that the humidity level exceeds a threshold humidity level; and increasing, by a heating device of the convection equipment, the temperature in the drying chamber in response to the temperature sensor detecting that the temperature within the drying chamber is decreased below a threshold temperature level.

In some embodiments, the method may further include: monitoring, by one or more load cells of the sensing equipment, a mass of the organic material held within the drying chamber; and equalizing, by a purge valve of the flow control equipment, a pressure within the drying chamber with an external pressure in response to the one or more load cells detecting that the mass of the organic material is decreased to a target level.

In some embodiments, the one or more load cells may be arranged below a product container configured to hold the organic material within the drying chamber.

In some embodiments, the one or more load cells may be arranged above a product container configured to hold the organic material within the drying chamber.

In some embodiments, the method may further include: monitoring, by a moisture sensor of the sensing equipment, a moisture level of the organic materials held within the drying chamber; and equalizing, by a purge valve of the flow control equipment, a pressure within the drying chamber with an external pressure in response to the moisture sensor detecting that the moisture level of the organic material is decreased to a target moisture level.

The above summary does not include an exhaustive list of all the aspects and features of the present disclosure. It is contemplated that the disclosure includes all the systems and methods that can be practiced from various suitable combinations of the various aspects and features described above, as well as those described in the Detailed Description below. Further, such combinations may have particular advantages that are not specifically described herein. Thus, other aspects and features of the present invention will be apparent from the accompanying drawings and from the detailed description that follows.

### BRIEF DESCRIPTION OF THE DRAWINGS

The above and other aspects and features of the present invention will become more apparent to those skilled in the art from the following detailed description of the example embodiments with reference to the accompanying drawings, in which like reference numerals indicate like or similar elements throughout.

FIG. 1 is a diagram of a system for drying organic materials, according to some example embodiments.

FIG. 2 is a diagram of a control module used by the system for drying organic materials, according to some example embodiments.

FIG. 3 is an isometric view of a drying apparatus for organic materials, according to some example embodiments.

FIG. 4 is an isometric view of a product container tray, according to some example embodiments.

FIG. 5 is a flow diagram of a method for drying organic materials, according to some example embodiments.

FIG. 6 is a flow diagram of a drying mode for drying the organic materials, according to some example embodiments.

### DETAILED DESCRIPTION

Hereinafter, example embodiments will be described in more detail with reference to the accompanying drawings, in which like reference numbers refer to like or similar elements throughout. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Further, descriptions of features or aspects within each example embodiment should typically be considered as available for other similar features or aspects in other example embodiments. Unless otherwise noted, like reference numerals denote like elements throughout the attached drawings and the written description, and thus, descriptions thereof may not be repeated.

In the drawings, the relative sizes of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

One or more example embodiments of the present disclosure relate to systems and methods for drying organic materials using controlled atmospheric conditions within a drying chamber. It should be appreciated to those skilled in the art that the various feature and aspects of the non-limiting example embodiments described herein may be used or variously modified to dry various different kinds of organic materials, including, but not limited to, for example, meats, fruits, herbs, seeds/husks, stems, barks, leaf fibers, roots, and/or the like, all without departing from the spirit and scope of the present invention. Some of these organic materials contain various organoleptic and even medicinal properties that may be lost or reduced when treating the materials to dry the materials for further processing or consumption using the drying methods described in the background section. Accordingly, in some embodiments, these and other various organic materials may be dried according to one or more of the various example embodiments described herein to reduce or minimize loss of the organoleptic and/or medicinal properties of the organic materials.

In various embodiments, at least some of the drawbacks described in the background section of the present disclosure may be overcome through various example embodiments of the systems and methods for drying organic materials as described in the present disclosure. In some embodiments, the systems and methods described herein may employ various different elements and components that enable a high level of control of atmospheric conditions within a drying chamber. For example, through the usage of a vacuum generating device, for example, such as a vacuum pump, a vacuum (e.g., a partial vacuum) may be created within the drying chamber, which may accelerate the rate of drying of the organic materials. In some embodiments, suitable gases may be introduced into the drying chamber to help maintain or substantially maintain various properties of the organic materials (e.g., organoleptic and/or medicinal properties). In some embodiments, convection equipment may be used within the drying chamber to rapidly dry the organic materials while minimizing or reducing loss of the various properties of the organic materials (e.g., organoleptic and/or medicinal properties).

According to some embodiments, systems and methods for drying organic materials may include flow control equipment, convection equipment, and sensing equipment. In some embodiments, the flow control equipment, the convection equipment, and the sensing equipment may be connected to relays that are connected to a processor. In some embodiments, the flow control equipment may be configured to regulate in-flows and out-flows of one or more gases (e.g., air, oxygen, nitrogen, helium, and/or the like, or any suitable gas mixtures) within a drying chamber. In some embodiments, the flow control equipment may include a main flow valve, a purge valve, one or more gas valves, a control valve, and/or a vacuum generating device (e.g., a vacuum pump). In some embodiments, the drying chamber may house or otherwise receive a product container with the organic materials placed within.

In some embodiments, the convection equipment may be configured to regulate the temperature and/or humidity of the drying chamber, and to enhance the drying speed of the organic materials. In some embodiments, the convection equipment may include, for example, a fan and a heating device. In some embodiments, the sensing equipment may be configured to measure various parameters (or atmospheric conditions within the drying chamber), for example, such as humidity, temperature, and/or pressure within the drying chamber.

In some embodiments, the sensing equipment may be configured to measure the mass of the organic material in the product container (or the combined mass of the organic material and the product container) and/or moisture of the organic materials. For example, in some embodiments, the sensing equipment may include one or more pressure sensors, temperature sensors, humidity sensors, and load cells, which may be arranged (or installed) within or near the drying chamber. In some embodiments, the load cells may be configured to measure the mass of the organic material (or the combined mass of the organic material and the product container). In some embodiments, in lieu of, or in addition to the load cells, the sensing equipment may include moisture sensors arranged or otherwise located in proximity to the organic materials to measure the moisture of the organic materials in the product container.

In some embodiments, the sensing equipment may include a pressure gauge, which may be located outside of (or exterior to) the drying chamber. In some embodiments, the pressure sensors may include any suitable pressure sensors or combination of pressure sensors, for example, such as pressure transducers, barometric altimeters, and/or the like. In some embodiments, the vacuum generating device may include any suitable type of device configured to generate a low pressure environment, for example, such as a vacuum pump, a regenerative blower, a venturi generator, and/or the like. In some embodiments, the processor executes instructions in the form of programs stored in memory, and is configured to control the flow control equipment and the convection equipment based on input data received from the sensing equipment.

In some embodiments, as the organic materials are introduced into the product container, all of the flow control and convection equipment may be inactive. Then, a door that isolates the drying chamber from the rest of the system for drying the organic materials may be closed. The system and method then proceeds by opening the main flow valve and activating the vacuum generating device in order to extract air, other gas mixtures, and humidity from the drying chamber, resulting in a vacuum (or a partial vacuum) within the drying chamber. The vacuum (e.g., the partial vacuum) may help to enhance the speed at which the organic materials may be dried, while eliminating or reducing risks of contamination through spores or other risk elements.

In some embodiments, when a target pressure is reached within the drying chamber, the gas valves may be opened to adjust a ratio of a gas mixture within the drying chamber. In some embodiments, the gas valves may allow mixed gases, such as air, to flow into the drying chamber. In some embodiments, the gas valves may allow other gases, such as pure gases (e.g., oxygen, nitrogen, helium, and/or the like), which may be useful for maintaining various properties of the organic materials within the product container. In some embodiments, the gas valves may include one or more desiccant materials (e.g., desiccant columns) or other suitable drying agents in order to dry the gases flowing into the drying chamber.

As a non-limiting example, when drying organic materials such as cannabis or cannabinoid-containing plant organic materials, a target pressure within the drying chamber may be, for example, about 15 to about 26 (or 15 to 26) inches of mercury (inHg). In some embodiments, a desired range of the target pressure may be about 18 to about 25 inHg (or 18 to 25 inHg). Other examples of the target pressure include about 5 to about 26 inHg (or 5 to 26 inHg), with a desired range of about 8 to about 24 inHg (or 8 to 24 inHg). However, the present disclosure is not limited thereto, and other suitable target pressures may be used or adjusted depending on the kind of organic materials to be dried and the organoleptic and/or other properties of the organic materials. Further, it should be understood that in various embodiments, the target pressure may refer to either a static pressure or a transient pressure that can change during the course of drying.

In some embodiments, after opening the one or more gas valves, a control valve configured to regulate the pressure within the drying chamber may be opened, and the convection equipment (e.g., the fan and the heating device) may be activated within the drying chamber to initiate a drying mode or a drying cycle. The drying mode or the drying cycle as used herein refers to a mode of operation of the system for drying organic materials, wherein the convection equipment is cycled on and off while a low pressure is maintained within the drying chamber, accelerating the drying process of the organic materials.

In some embodiments, the fan may be activated in order to release the humidity of the organic materials and to keep a turbulent flow of the gas mixture and heat within the drying chamber. In some embodiments, the airflow of the fan within the drying chamber may be adjusted depending on the organic materials being dried, the amount of organic materials within the product container, and/or the dimensions of the drying chamber and product container, amongst other factors. The heating device may be activated in order to prevent or reduce evaporative heat loss from the partial vacuum within the drying chamber.

According to an embodiment, the fan and heating device may be separate from each other. In this embodiment, the fan, heating device, and product container may be each attached to one or more inner walls and/or to the floor of the drying chamber by any suitable attachment method (e.g., screws, adhesives, weldings, mounting brackets, and/or the like). In other embodiments, the fan and heating device may be integrated in a single convection device, such that the single convection device may be adjusted to be attached to the product container, and the product container may be arranged or located on top (e.g., directly on top) of the single convection device. However, the present disclosure is not limited thereto, and the various components of the system may be arranged, attached, or otherwise located with respect to each other through any suitable arrangements.

In some embodiments, it may be desirable to maintain the gas mixture and heat turbulent within the drying chamber, because of a high degree of diffusibility of the mass, momentum, and energy (i.e., heat), amongst other factors, resulting in an increased heat transfer and enhanced contact areas between the organic materials and the gas mixture and heat within the drying chamber.

In some embodiments, in order for the turbulent gas mixture and heat to be able to penetrate the product container and to enhance the drying speed of the organic materials, individual product container trays that form the product container may include relatively small openings and bigger, air passages at the center of the product container trays. The organic materials may sit still at the bottom of the product container trays while the gas mixture and heat dry the organic materials. In some embodiments, a lid may be placed on top of the product container, and be adjusted to push most of the air, other gas mixtures, heat, and/or the like out through the sides of the product container. In some embodiments, a door that isolates the drying chamber from the other components of the system may be adjusted to prevent or reduce air, other gas mixtures, heat, and/or the like from entering or exiting the drying chamber, thus enabling improved control of the atmospheric conditions within the drying chamber.

In some embodiments, the sensor equipment may include one or more sensor devices for measuring the atmospheric conditions within the drying chamber, for example, such as humidity, temperature, pressure, moisture, and/or the like. For example, various embodiments, the sensor equipment may include one or more temperature sensors, one or more humidity sensors, and one or more pressure sensors that are configured to measure the temperature, humidity, and pressure, respectively, within the drying chamber. In some embodiments, the sensor equipment generates sensed data from the various measurements by the sensor devices, which is sent to the processor to control and regulate the activation and deactivation cycles of the convection equipment (e.g., the fan and heating device).

In some embodiments, when the heating device elevates the temperature within the drying chamber to a target high temperature range for a certain amount of time, then the heating device may be momentarily deactivated. After the heating device has been deactivated, the temperature within the drying chamber may decrease, such that when the temperature reaches a target low temperature range for a certain amount of time, then the heating device may again be activated. The target high and target low temperature ranges may be determined depending on the organic materials to be dried, but may generally be kept within a range where the properties of the organic materials may be preserved (e.g., below the volatization point of certain organic chemicals contained in the organic materials).

In further embodiments, activating the fan creates convection to drive off moisture within the drying chamber, the humidity within the drying chamber may increase. When the rate of change of the relative humidity within the drying chamber decreases such that there is no more significant change in the relative humidity for a certain amount of time, then the fan may be deactivated. After the fan has been deactivated, because the vacuum generating device is constantly removing humidity, the relative humidity within the drying chamber may decrease. When the rate of change of the relative humidity within the drying chamber decreases such that there is no significant change in the relative humidity for a certain amount of time, then the fan may again be activated.

During the process, humidity is being pulled out by the vacuum generating device, the fan cycles on and off to release humidity from the organic materials, and the heating device cycles on and off to prevent heat loss in the form of evaporative cooling. As a result, the mass of the organic materials within the product container decreases, reducing the overall mass of the product container. The mass of the product container may constantly be measured by load cells, which may be installed in areas beneath or above the product container. Thus, when the mass of the product container reaches a target level, the system and method may proceed by turning off the vacuum generating device, fan, and heating device, and closing the main flow valve, gas valves, and control valve, thereafter opening a purge valve. The purge valve may be opened in order to allow outside air to come into the drying chamber, equalizing the pressure within the drying chamber to the atmospheric pressure (or external pressure). Subsequently, the door separating the drying chamber with the rest of the system for drying organic materials may be opened and the organic materials may be removed.

Those skilled in the art might appreciate that the processor may not only switch electrical current to the flow control and convection equipment, but that the processor may as well vary the amount of electrical current flow to these devices, for example, through power transistors, field-effect transistors, and others, in place of one or more of the relays. Hence, additional features may be provided through user interface elements, such as displays and keyboards, for customization of the pressure, humidity, gas mix ratios, air flow and heating emissions by respectively adjusting parameters of the flow control and convection equipment.

Depending on factors such as the amount of organic materials, the type of organic materials, the desired throughput, etc., the different elements of the system and method for drying organic materials may be adjusted in size, type, material, and number to comply with the requirements of the desired application.

As an illustration, examples will be provided using cannabis plant material or other plant material containing cannabinoids. Cannabis plants include wild cannabis plants, including but not limited to the species Cannabis sativa, Cannabis indica, and Cannabis ruderalis, as well as their variants.

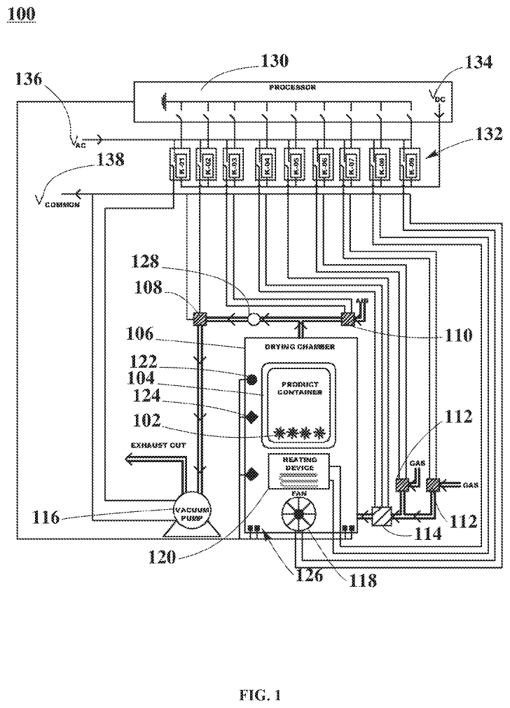

FIG. 1 depicts a diagram of a drying system 100 for drying organic materials, according to an embodiment. In FIG. 1, organic materials 102 that is ready for drying may be loaded into a product container 104 located within a drying chamber 106. As the organic materials 102 is introduced into the product container 104, flow control and convection equipment of the system 100 for drying organic materials may be inactive.

According to an embodiment, the flow control equipment, which may be configured to regulate flows, such as gases, within the drying chamber 106, may include a main flow valve 108, a purge valve 110, one or more gas valves 112, a control valve 114, and a vacuum pump 116, all of which may be located in areas outside of the drying chamber 106. For the purpose of this detailed description, the vacuum generating device is referred to as a vacuum pump, however any suitable vacuum generating device including vacuum pumps, regenerative blowers, venturi generators and the like may be used. The convection equipment, which may be configured to regulate the temperature and humidity of the drying chamber 106 in order to dry the organic materials 102 within the product container 104, may include a fan 118 and a heating device 120, and may be located within the drying chamber 106.

Valves used in the current disclosure may include any type of valve suitable for enabling and controlling the flow of air and other gases, such as ball valves, gate valves, plug valves, butterfly valves, globe valves, etc.

The system 100 for drying organic materials may also include sensing equipment configured to measure parameters such as humidity, temperature, pressure, mass, and moisture of the organic materials 102 within the drying chamber 106. The sensing equipment may include one or more pressure sensors 122, temperature and humidity sensors 124, and load cells 126, all of which may be located in areas within or near the drying chamber 106, and a pressure gauge 128, which may be located outside of the drying chamber 106. The pressure sensors 122 may include any suitable type of pressure sensor, such as a pressure transducer, barometric altimeters, and the like.

After the placement of the organic materials 102 within the product container 104, a door separating the drying chamber 106 and the rest of the system for drying organic materials 100 may be shut. Then, the system may open the main flow valve 108 and activate the vacuum pump 116 in order to extract air, other gas mixtures, humidity, and other volatile substances from the drying chamber 106, creating a partial vacuum within the drying chamber 106. The partial vacuum may help to enhance the speed at which the organic materials 102 is dried while eliminating or reducing risks of contamination of the organic materials 102 through spores or other risk elements.

When the pressure gauge 128 displays a target pressure within the drying chamber 106, then the system proceeds by opening the gas valves 112 in order to control gas mixture ratios to be introduced into the drying chamber 106. Subsequently, the system proceeds by opening the control valve 114 in order to regulate the pressure within the drying chamber 106.

According to an embodiment, when drying organic materials 102 such as cannabis or cannabinoid-containing organic materials 102, a target pressure within the drying chamber 106 which may be suitable to activate the one or more gas valves 112 and subsequently the control valve 114 may be of about 15 to about 26 inHg, with a desired range of about 18 to about 25 inHg. Other examples of the target pressure include about 5 to about 26 inHg (or 5 to 26 inHg), with a desired range of about 8 to about 24 inHg (or 8 to 24 inHg). These pressure ranges may ensure that enough air, gas mixtures, humidity and other volatile particles within the drying chamber 106 are extracted from the drying chamber 106, which may result in a more efficient drying process of the organic materials 102. However, the present disclosure is not limited thereto, and other target pressures may be suitable and may be adjusted depending on the type of organic materials 102 to be dried and the organoleptic and/or other properties of the organic materials 102. Also, it is understood in all embodiments that the target pressure referred to could be either a static pressure or a transient pressure that can change during the course of drying.

According to an embodiment, the gas valves 112 may allow mixed gases, such as air, to come into the drying chamber 106. In other embodiments, the gas valves 112 may allow other gases into the drying chamber 106, such as pure gases (e.g., oxygen, nitrogen, helium, etc.), which may be useful for maintaining certain properties of the organic materials 102. For example, in the case of a cannabis or other cannabinoid-containing organic materials 102, a suitable gas to enhance the properties of the cannabinoid-containing organic materials 102 may include, without limitation, inert gases such as nitrogen, which may displace oxygen within the drying chamber 106 and product container 104 and thus prevent oxidation of the cannabis and the breaking down of important components such as THC.

In other embodiments, the gas valves 112 may include desiccant columns or other suitable drying agents in order to dry gases coming into the drying chamber 106.

After opening the one or more gas valves 112 and subsequently opening the control valve 114, the system 100 for drying organic materials may proceed by performing a drying mode. The drying mode, or drying cycle, may refer herein to a mode of operation of the system 100 for drying organic materials wherein convection equipment is activated and cycle on and off while maintaining a low pressure within the drying chamber 106, accelerating the drying process of the organic materials 102. For example, the drying mode may begin by activating the fan 118 and heating device 120.

The fan 118 may be activated in order to release the humidity of the organic materials 102 and to keep a turbulent flow of the gas mixture within the drying chamber 106. The airflow of the fan within the drying chamber may be adjusted depending on the organic materials being dried, the amount of organic materials within the product container, and the dimensions of the drying chamber and product container, amongst other factors. The heating device 120 may be activated in order to prevent evaporative heat loss from the partial vacuum within the drying chamber 106.

Sensing devices, such as one or more temperature and humidity sensors 124 and one or more pressure sensors 122 are configured to measure the temperature, humidity, and pressure, respectively, within the drying chamber 106 in order to regulate the cycles of activation and deactivation of the fan 118 and heating device 120. Information sent by the temperature and humidity sensors 124 is used by the system 100 for drying organic materials to regulate activation/deactivation cycles of the fan 118 and heating device 120 as performed during the drying mode.

In some embodiments, when performing the drying mode, the heating device 120 elevates the temperature within the drying chamber 106 to a target high temperature (e.g., a first threshold temperature level) for a certain amount of time, then the heating device 120 may be momentarily deactivated. After the heating device 120 has been deactivated, the temperature within the drying chamber 106 may decrease, such that when the temperature reaches a target low temperature (e.g., a second threshold temperature level) for a certain amount of time, then the heating device 120 may again be activated. The target high and target low temperature ranges may be determined depending on the organic materials 102 to be dried, but may generally be kept within a range where the properties of the organic materials 102 may be preserved (e.g., below the volatization point of certain organic chemicals contained in the organic materials 102).

In further embodiments, activating the fan 118 creates convection to drive off moisture within the drying chamber 106, the humidity within the drying chamber 106 may increase. When the rate of change of the relative humidity within the drying chamber 106 decreases such that there is no more change in the relative humidity for a certain amount of time, then the fan 118 may be deactivated. After the fan 118 has been deactivated, because the vacuum pump 116 is constantly removing humidity, the relative humidity within the drying chamber 106 may decrease. When the rate of change of the relative humidity within the drying chamber 106 decreases such that there is no more change in the relative humidity for a certain amount of time, then the fan 118 may again be activated.

During the process, humidity is being pulled out by the vacuum pump 116, the fan 118 cycles on and off to release humidity from the organic materials 102, and the heating device 120 cycling on and off to prevent heat loss in the form of evaporative cooling. As a result, the mass of the organic materials 102 within the product container 104 decreases, decreasing the overall mass of the product container 104. The mass of the product container 104 may be constantly measured by load cells 126 which may be installed in areas beneath or above the product container 104. Thus, when the mass of product container 104 reaches a target level, the system may deactivate the drying mode, shutting down the vacuum pump 116, fan 118, and heating device 120, closing the main flow valve 108, the gas valves 112, and control valve 114, and opening the purge valve 110 in order to allow outside air to come into the drying chamber 106, equalizing the pressure within the drying chamber 106 to the atmospheric pressure (or external pressure). Subsequently, the door separating the drying chamber 106 with the rest of the system for drying organic materials 100 may be opened and the organic materials 102 may be removed.

Instructions to control the various electrical equipment of the system for drying organic materials 100 may be stored in a memory (not shown) and executed by a processor 130. The memory may generally store programs, executable code, and data such as timing intervals and temperature, humidity, pressure, and mass ranges. The processor 130 may communicatively connect to the various sensing devices as well as to the various flow control and convection equipment of the system 100 for drying organic materials. Furthermore, the processor 130 may control the activation and deactivation cycles of the flow control and convection equipment based on the parameters measured by the sensing devices. Each of the flow control and convection equipment within the system 100 for drying organic materials may additionally be individually connected to relays 132. The relays 132 are electrically-operated switches configured to control the activation and deactivation of each of the flow control and convection equipment as instructed by the processor 130.

The different elements of the system for drying organic materials 100 may be powered in any way known in the industry. For example, as shown in FIG. 1., the processor 130 may be connected to a direct current (DC) voltage source 134 and powered by said DC voltage source 134. Further in this example, and as shown in FIG. 1, the rest of the elements of the system 100 for drying organic materials may be connected to an alternating current (AC) voltage source 136 through the various relays 132 and may be powered by said AC voltage source 136. The various circuitry may connect at a common point, or a common voltage 138, before connecting to ground or floating above ground connection for activation.

Those skilled in the art should appreciate that the processor 130 may not only switch electrical current to the flow control and convection equipment, but that the processor 130 may as well vary the amount of electrical current flow to these devices, for example, through power transistors, field-effect transistors, and others, in place of one or more of the relays 132. Hence, additional features may be provided through user interface elements, such as displays and keyboards (not shown), for customization of the pressure, humidity, gas mix ratios, air flow and heating emissions by respectively adjusting parameters of the flow control and convection equipment.

Depending on factors such as the amount of organic materials 102, the type of organic materials 102, the desired throughput, etc., the different elements shown in the system for drying organic materials 100 may be adjusted in size, type, material, and number to comply with the requirements of the desired application.

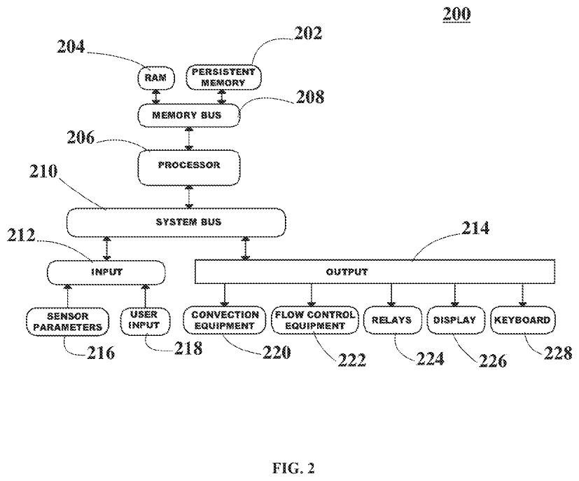

FIG. 2 depicts an exemplary control module 200 that may be used by the system 100 for drying organic materials depicted in FIG. 1, according to an embodiment. The depicted exemplary control module 200 is shown in its simplest form. Different architectures are known that accomplish similar results in a similar fashion, and the system 100 for drying organic materials is not limited in any way to any particular system architecture or implementation.

In FIG. 2, instructions in the form of programs may be stored in a persistent memory 202 and loaded into a random access memory (RAM) 204, such that the processor 206 may execute and run said programs in order to perform the different steps required to dry organic materials. The processor 206 may be any suitable processor, typically a microcontroller processor. The persistent memory 202 and RAM 204 interface through, for example, a memory bus 208. The RAM 204 may be any memory suitable for connection and operation with the selected processor 130, such as SRAM, DRAM, SDRAM, RDRAM, DDR, DDR-2, etc. The persistent memory 202 may be any type of memory suitable for persistently storing data, for example, flash memory, read only memory, battery-backed memory, magnetic memory, etc. For example, the persistent memory 202 may be removable, in the form of a memory card of appropriate format such as secure digital (SD) cards, micro SD cards, compact flash, etc.

Also connected to the processor 206 may be a system bus 210 for connecting peripherals such as input ports 212 and output drivers 214. For example, the various sensors 216 and a user input interface 218 may be connected to the input ports 212 and may be configured to provide parameter and feedback details to the processor 206 for controlling the various output drivers 214. The output drivers 214 may include, for example, convection equipment 220, flow control equipment 222, relays 224, display 226 whereby users can view the different parameters driving the system 100 for drying organic materials, and a keyboard 228 that users may use in order to input system parameters, if desired.

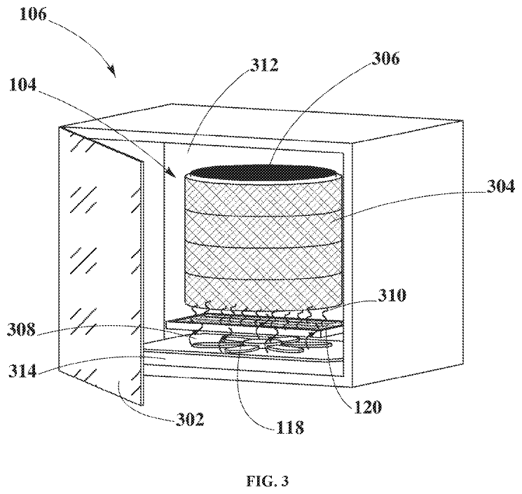

FIG. 3 depicts an isometric view of a drying chamber 106 depicted in FIG. 1, according to an embodiment. Thus, some of the numerals may be the same as those in FIG. 1. The drying chamber 106 may include a door 302, a fan 118, a heating device 120, a product container 104, one or more product container trays 304, and a lid 306. Other elements, such as temperature and humidity sensors, pressure sensors, and load cells or moisture sensors, may also be included within or near the drying chamber 106.

The door 302 may be adjusted to avoid air, other gas mixtures, or heat, to enter or escape the drying chamber 106, thus enabling a better control of the atmospheric conditions within the drying chamber 106. The lid 306 may be adjusted to push most of air, other gas mixtures, and heat, out through the sides of the product container 104.

In FIG. 3, the fan 118 may circulate air, other gas mixtures, and heat within the drying chamber 106 and produce a turbulent flow 308, while the heating device 120 may emit heat 310. Keeping gas mixtures and heat 310 turbulent within the drying chamber 106 may be desirable, amongst other reasons, because of a high degree of diffusibility of the mass, momentum, and energy (i.e., heat 310), resulting in an increased heat transfer and enhanced contact areas between the organic materials and the gas mixture and heat 310 within the drying chamber 106.

According to an embodiment, and as shown in FIG. 3, the fan 118 and heating device 120 may be separate from each other. In this embodiment, the fan 118, heating device 120, and product container 104 are each attached to one or more inner walls 312 and/or to the floor 314 of the drying chamber 106 through any suitable attachment method (e.g., screws, adhesives, weldings, mounting brackets, and/or the like). In other embodiments, the fan 118 and heating device 120 may be coupled together into a single convection device, such that the single device may be adjusted to be attached to the product container 104 and that the product container 104 may directly sit on top of the single convection device. Other non-limiting configurations may be considered when attaching the different elements shown in FIG. 3.

Suitable materials for the product container 104 include aluminum, steel, acrylic and any other rigid material that can be placed in a vacuum chamber without compromising the integrity of the organic materials.

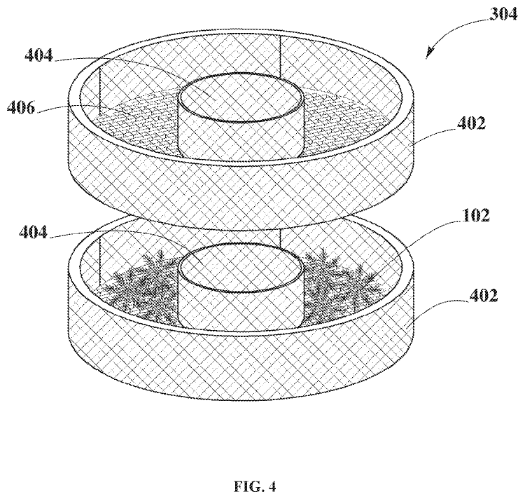

FIG. 4 depicts an isometric view of two product container trays 304, according to an embodiment.

In order for the turbulent flow 308 and heat 310, such as shown in FIG. 3, to be able to penetrate evenly the product container 104 and to enhance the drying of the organic materials 102, the individual product container trays 304, as shown in FIG. 4, may include relatively small openings 402 and bigger, air passages 404. The organic materials 102 may sit still at the base of the product container trays 304 while the gas mixture and heat may dry the organic materials 102.

Although the shape of the product container trays 304 shown in FIG. 4 is cylindrical, any other suitable shape may be used. However, the shape of the product container trays 304 may need to be such that the organic materials 102 are able to sit evenly on the inner surface 406 of the product container trays 304. Additionally, the shape and size of the product container trays 304 may be selected depending on the size and shape of the drying chamber where the product container trays 304 may be located.

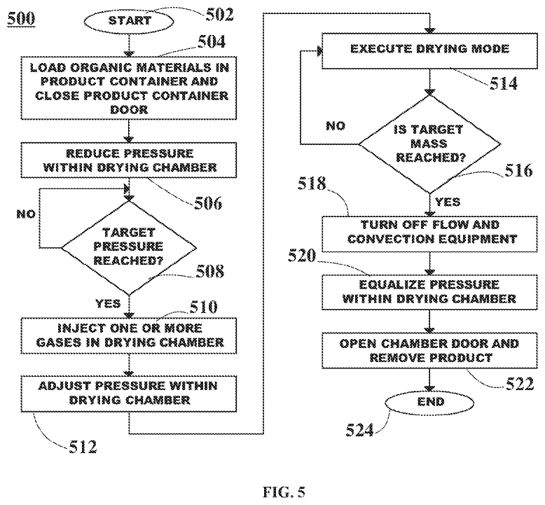

FIG. 5 depicts a block diagram of a method for drying organic materials 500 employing the system, according to an embodiment. The method 500 may, for example, be executed by a system according to an embodiment of the present disclosure, such as the systems discussed with regard to FIGS. 1 to 4. A method such as the method for drying organic materials 500 may be stored in the form of programs in a persistent memory and loaded into a random access memory, such that a processor may execute and run said programs.

In FIG. 5, the method for drying organic materials 500 may start at steps 502 and 504 by loading organic materials in the product container and closing the drying chamber door. Then, in step 506, the method may proceed by reducing the pressure within the drying chamber. In an example, and making reference to FIG. 1, the method 500 may reduce the pressure within the drying chamber 106 by opening the main flow valve 108 and activating the vacuum pump 116 in order to extracts air, other gas mixtures, humidity, and other volatile elements present within the drying chamber 106.

The method may then proceed in check 508 by checking, through sensing devices (e.g., pressure sensors 122 and pressure gauge 128 of FIG. 1), whether a target pressure has been reached. If the target pressure is not yet reached, the method loops back to check 508 until the target pressure is reached. Subsequently, after the target pressure is reached, the method continues in step 510 by injecting one or more gases into the drying chamber. In an example and making reference to FIG. 1, the method 500 may inject one or more gases by opening one or more gas valves 112, enabling users to adjust air or other gas mixture ratios that may enter the drying chamber 106, which may maintain certain properties of the organic materials. Then, in step 512, the method continues by adjusting the pressure within the drying chamber. In an example and making reference to FIG. 1, adjusting the pressure within the drying chamber 106 may be performed by opening the control valve 114 in order to adjust the pressure within the drying chamber 106. In step 514, the method may proceed by executing a drying mode, which may involve activation and deactivation of convection equipment within the drying chamber in order to enhance the drying speed of the organic materials.

As a result of the fan and heating device activation and deactivation cycles within the partial vacuum of the drying chamber, the mass of the organic materials within the product container decreases, decreasing the overall mass of the product container. The mass of the product container may be constantly measured by load cells which may be installed in areas beneath or above the product container. Thus, in check 516, the method proceeds by checking whether a target mass of the product has been reached, in which case, as seen in step 518, the method turns off the flow and convection equipment and proceeds, in step 520, to equalize the pressure within the drying chamber. As an example and making reference to FIG. 1, the method 500 may equalize the pressure within the drying chamber 106 by opening the purge valve 110 in order to allow outside air to come into the drying chamber 106 and equalize the pressure of the drying chamber to the atmospheric pressure (or external pressure). Finally, the process ends in steps 522 and 524 when the door separating the drying chamber with the rest of the system is opened and the product is removed.

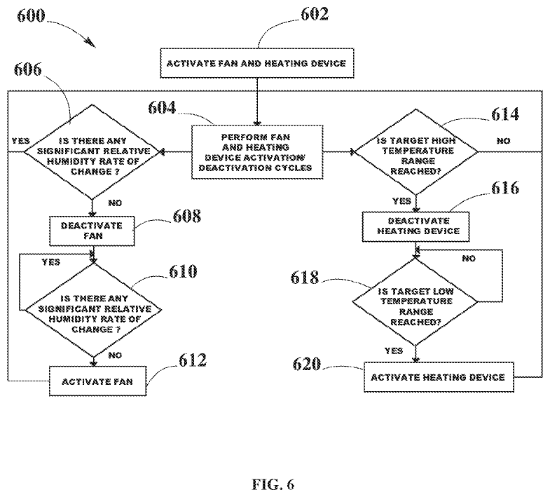

FIG. 6 depicts a block diagram of a drying mode 600 according to an embodiment of the current disclosure. The drying mode 600 may, for example, be executed by a system according to an embodiment of the present disclosure, such as the systems discussed with regard to FIGS. 1 to 4, and may be implemented by a method, such as method 500 of FIG. 5.

Drying mode 600 may start in step 602 by activating convection equipment, such as a fan and heating device of FIG. 1. Then, drying mode 600 may proceed in step 604 by performing fan and heating device activation and deactivation cycles. For the fan, these cycles may depend on whether a target high and a target low humidity are reached. For the heating device, these cycles may depend on whether a target high or a target low temperature are reached. In certain embodiments, the drying mode 600 may also take into consideration the time in which these target high and low humidity and temperatures are reached.

Because activating the fan creates convection to drive off moisture within the drying chamber, the humidity within the drying chamber may increase to a certain level (e.g., a threshold humidity level). Thus, as seen in check 606, the drying mode may proceed by checking whether a significant relative humidity rate of change has been achieved. If a significant rate of change is not taking place anymore, i.e., the humidity in the drying chamber is not increasing significantly, then the drying mode may proceed by deactivating the fan, as seen in step 608. Then, because the vacuum pump is constantly drawing humidity out of the drying chamber, and since the fan is deactivated, the humidity within the drying chamber may decrease. Thus, as seen in check 610, the drying mode 600 may check whether a significant relative rate of change has been achieved. If a significant rate of change is not taking place anymore, i.e., the humidity in the drying chamber is not decreasing significantly, then the drying mode 600 may proceed by activating the fan, as seen in step 612. Activating again the fan may lead to another increase in the humidity of the drying chamber, such that the drying mode loops back to step 604 by performing further fan and heating device activation and deactivation cycles, as required.

Occurring simultaneously with the fan activation and deactivation cycles described above, because activating the heating device raises the temperature within the drying chamber, the drying mode 600 may check whether a target high temperature range (or first threshold temperature level) has been reached, as seen in check 614. If a target high temperature range is reached, the drying mode 600 proceeds by deactivating the heating device, as seen in step 616. Then, because deactivating the heating device lowers the temperature within the drying chamber, the drying mode 600 proceeds by checking whether a target low temperature range (or second threshold temperature level) has been reached, as seen in check 618, in which case the drying mode 600, in step 620, activates again the heating device. Activating again the heating device leads to another increase in the temperature of the drying chamber, such that the method loops back to step 604 by performing further fan and heating device activation and deactivation cycles.

### Example Alternative Embodiments

The following example alternative embodiments may, for example, be executed by a system according to embodiments of the present disclosure, such as the system discussed with reference to FIGS. 1 to 4, and may be implemented by various methods according to various example embodiments of the present disclosure, such as the methods discussed with reference to FIGS. 5 and 6.

In a first alternative embodiment, and making reference to the system of FIG. 1, moisture sensors may be included in lieu of, or in addition to, the load cells 126. In this embodiment, the moisture sensors may measure the moisture of the organic materials 102 so that reaching a target moisture level (e.g., a threshold moisture level) may signal the processor 130 when the process is complete.

In a second alternative embodiment, and making reference to the system of FIG. 1, when starting operation of the system for drying organic materials 100, the system 100 may receive a user input of an initial moisture content or water activity of the organic material. In this embodiment, the load cells 126 and moisture sensors may be employed in conjunction. The initial moisture content or water activity information may be input in order for the processor to calculate the final mass of the organic materials 102 at the desired final moisture content. Reaching the target moisture level and thus, the target mass, may signal the processor when the process is complete.

In a third alternative embodiment, and making reference to the drying mode described in FIGS. 1 and 6, when performing fan and heating device activation and deactivation cycles, the fan 118 and vacuum pump 116 (or other suitable vacuum generating device) may be constantly running while temperature and humidity sensors 124 control the heating device 120 activation and deactivation cycles. During the process, the control valve 114 maintains the desired pressure. Reaching a target mass or a target moisture may signal the processor 130 when the process is complete.

In a fourth alternative embodiment, and making reference to the drying mode described in FIGS. 1 and 6, during the fan and heating device activation and deactivation cycles, when the high and low relative humidity values (e.g., the relative humidity rate of difference) from each of the fan activation and deactivation cycles only differ by a predetermined low percentage, or when the relative humidity rate of difference is constant for a determined amount of time, then the system for drying organic materials 100 may switch to a curing mode. In some examples, a suitable rate of difference between the high and low relative humidity may be of between about 3% and 7%. In an example of a high and low relative humidity difference of 5%, a high relative humidity may be of 40% relative humidity while a low relative humidity may be of 35%.

Further in this embodiment, the curing mode, which may also be referred to as a moisture equalization mode, may be a mode of operating the system for drying organic materials 100 that enhances the preservation of organic material properties by maintaining a low pressure inside the drying chamber without applying convection to the organic materials 102, resulting in an equalization of the moisture in both the core and surface of the organic materials 102. For example, when executing the curing mode, the fan 118 may turn off, the control valve 114 may close, and the vacuum pump 116 (or other suitable vacuum generating device) may decrease the pressure within the drying chamber 106 to a higher vacuum pressure than used in the drying mode. A suitable pressure within the drying chamber 106 during the curing mode may be of, for example, about 24 to about 26 inHg. Then, the main flow valve 108 may close and the vacuum pump 116 (or other suitable vacuum generating device) may be shut off. At this moment, the organic materials 102 are in a sealed partial vacuum chamber with all or most equipment deactivated. Core moisture (i.e., the moisture found within the organic materials 102) may migrate to the surface of the organic materials 102, equalizing the moisture of the organic materials 102 and increasing the relative humidity of the drying chamber. As the relative humidity rises, the vacuum within the drying chamber 106 may also drop due to increasing moisture in the chamber, increasing the pressure within the drying chamber 106. When the pressure within the drying chamber 106 increases to a certain pressure, such as between about 15 inHg and about 20 inHg, the vacuum pump 116 (or other suitable vacuum generating device) turns on, the main flow valve 108 opens, and the vacuum pump 116 (or other suitable vacuum generating device) reactivates in order to again decrease the pressure within the drying chamber 106 back to a target pressure. After a predetermined amount of time, or when a target relative humidity (e.g., a threshold humidity level) has been reached within the drying chamber 106, the system for drying organic materials 100 may switch to the drying mode and may operate by any of the features described in any of the above embodiments (e.g., the main embodiment or the third alternative embodiment). In this embodiment, the system for drying organic materials 100 may undergo as many drying and curing cycles as is necessary to reach the target moisture content and mass of the organic materials 102. Reaching a target mass or a target moisture may signal the processor 130 when the process is complete.

In a fifth alternative embodiment, and making reference to FIG. 1, the system for drying organic materials 100 may operate as stated in the main embodiment or in the third alternative embodiments until the organic materials 102 may reach a predetermined percent mass loss (e.g., 50% of the original mass or the like), as measured by the load cells 126, or a predetermined moisture content as measured by moisture sensors. Then, the system for drying organic materials 100 may switch to alternating between the drying and curing cycles described in any of the above embodiments (e.g., the fourth alternative embodiment). Reaching a target mass or target moisture may signal the processor 130 when the process is complete.

In a sixth alternative embodiment, and making reference to FIG. 1, the drying and curing cycles described in the fourth alternative embodiment are the only cycles performed. When the relative humidity stops lowering, the system of drying organic materials 102 may switch to the curing mode as described in any of the above embodiments (e.g., the fourth alternative embodiment). After a predetermined amount of time, or when a target relative humidity is reached, the system for drying organic materials 100 may switch to the drying mode as described in the second alternative embodiment. These cycles may alternate until the desired moisture and mass are reached. Reaching a target mass or target moisture may signal the processor 130 when the process is complete.

In a seventh alternative embodiment, and making reference to FIG. 1, the drying and curing cycles are the only cycles that are performed, but unlike the sixth alternative embodiment, a higher vacuum is not used in the curing mode. Instead, the same pressure as is used in the drying mode is maintained during the curing mode. Reaching a target mass or target moisture may signal the processor 130 when the process is complete.

In an eighth alternative embodiment, and making reference to FIG. 1, the vacuum pump 116 (or other suitable vacuum generating device) may reduce the pressure within the drying chamber 106 to a desired value with all the valves off except the main flow valve 108. Once the desired pressure is reached, the main flow valve 108 closes to maintain a desired pressure on the chamber, and then the vacuum pump 116 (or other suitable vacuum generating device) shuts off. The heating device 120 and fan 118 then start activation and deactivation cycles in any of the methods of the cycles listed in any of the main or alternative embodiments, causing the relative humidity of the drying chamber 106 to increase while keeping the gas mixtures and heat flow inside the chamber turbulent. Once the relative humidity and temperature within the drying chamber 106 reach a desired value (e.g., a threshold humidity level), the vacuum pump 116 (or other suitable vacuum generating device) may turn back on while all valves, except the main flow valve 108, remain closed. The main flow valve 108 then opens, allowing the vacuum pump 116 (or other suitable vacuum generating device) to reduce the pressure within the drying chamber 106, and the heating device 120 may be cycled and used to keep temperatures steady at a desired value while the vacuum pump 116 (or other suitable vacuum generating device) pulls moisture out of the chamber and allows the relative humidity to drop again. Once the relative humidity reaches a desired low range, the cycle repeats by turning off the main flow valve 108 and the vacuum pump 116 (or other suitable vacuum generating device). The cycle repeats until reaching a target mass or target moisture, which may signal the processor 130 when the process is complete.

In a ninth alternative embodiment, and making reference to FIG. 1, the system for drying organic materials 100 operates as described in the eighth alternative embodiment (or any other suitable embodiments). However, before the vacuum pump 116 (or other suitable vacuum generating device) turns off, the control valve 114, along with one or more gas valves 112, may open to allow air or other gases into the drying chamber 106 while the relative humidity of the chamber drops as the extracted moisture from the organic materials 102 are evacuated from the drying chamber 106. Reaching a target mass or target moisture may signal the processor 130 when the process is complete.

In a tenth alternative embodiment, and making reference to FIG. 1, the curing mode described in the fourth alternative embodiment does not periodically reduce pressure to reach a higher vacuum within the drying chamber 106. The pressure increases due to a rising relative humidity and the curing mode stops when a target relative humidity or target pressure are reached, thereafter alternating with the drying mode as described in any of the previously described alternative embodiments. Reaching a target mass or target moisture may signal the processor 130 when the process is complete.

In an eleventh alternative embodiment, and making reference to FIG. 1, the vacuum pump 116 (or other suitable vacuum generating device) is configured to provide sufficient airflow for turbulence to take place within the drying chamber 106, in which case no fan 118 may be required within the drying chamber 106.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present invention.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present

The terminology used herein is for the purpose of describing particular embodiments and is not intended to be limiting of the present invention. As used herein, the singular forms “a” and “an” are intended to include the plural forms as well, unless the context clearly indicates otherwise. It will be further understood that the terms “comprises,” “comprising,” “includes,” and “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

The electronic or electric devices and/or any other relevant devices or components according to embodiments of the present invention described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the exemplary embodiments of the present invention.

Unless otherwise defined, all terms (including technical and scientific terms) used herein have the same meaning as commonly understood by one of ordinary skill in the art to which the present invention pertains. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

While various example embodiments have been described and shown in the accompanying drawings, it is to be understood that such embodiments are merely illustrative of and not restrictive on the present invention, and that the present invention is not limited to the specific constructions and arrangements shown and described. Accordingly, various modifications may be made to the example embodiments described herein, all within the spirit and scope of the present invention as defined in the following claims, and their equivalents.

What is claimed is:

1. A system for drying an organic material, the system comprising:
a drying chamber configured to hold the organic material under controlled atmospheric conditions;
convection equipment configured to regulate temperature and humidity within the drying chamber;
flow control equipment configured to regulate flow of one or more gases in and out of the drying chamber;
sensing equipment configured to sense the atmospheric conditions of the drying chamber;
a processor; and
memory coupled to the processor and storing instructions that, when executed by the processor, cause the processor to:
receive sensed data from the sensing equipment; and
control the convection equipment and the flow control equipment based on the sensed data.

2. The system of claim 1, wherein:
the flow control equipment comprises a main flow valve, and a vacuum generating device; and
the instructions cause the processor to open the main flow valve and activate the vacuum generating device to remove air, humidity, and/or the one or more gases from the drying chamber to generate a vacuum in the drying chamber.

3. The system of claim 1, wherein:
the flow control equipment comprises one or more gas valves configured to adjust a ratio of a gas mixture within the drying chamber, the gas mixture corresponding to a mixture of the one or more gases that preserves one or more properties of the organic material; and
the instructions further cause the processor to open the one or more gas valves to introduce the gas mixture into the drying chamber.

4. The system of claim 1, wherein:
the sensing equipment comprises a temperature sensor, and a humidity sensor; and
the instructions further cause the processor to control the convection equipment to cycle through one or more activation and deactivation cycles based on the temperature detected by the temperature sensor and the humidity detected by the humidity sensor.

5. The system of claim 4, wherein:
the convection equipment comprises a fan and a heating device; and
the instructions further cause the processor to:
control the fan to reduce the humidity in the drying chamber in response to the humidity sensor detecting that a humidity level within the drying chamber exceeds a threshold humidity level; and
control the heating device to increase the temperature in the drying chamber in response to the temperature sensor detecting that the temperature within the drying chamber decreases below a threshold temperature level.

6. The system of claim 1, wherein:
the sensing equipment comprises one or more load cells configured to measure a mass of the organic material held within the drying chamber;
the flow control equipment comprises a purge valve; and
the instructions further cause the processor to control the purge valve to equalize a pressure within the drying chamber with an external pressure in response to the one or more load cells detecting that the mass of the organic material is decreased to a target level.

7. The system of claim 6, wherein the one or more load cells are arranged below a product container configured to hold the organic material within the drying chamber.

8. The system of claim 6, wherein the one or more load cells are arranged above a product container configured to hold the organic material within the drying chamber.

9. The system of claim 1, wherein:
the sensing equipment comprises one or more moisture sensors configured to measure a moisture level in the organic material held within the drying chamber;
the flow control equipment comprises a purge valve; and
the instructions further cause the processor to control the purge valve to equalize a pressure within the drying chamber with an external pressure in response to the one or more moisture sensors detecting that the moisture level of the organic material is decreased to a target moisture level.

10. The system of claim 1, wherein the organic material corresponds to a portion of a plant.

11. A method for drying an organic material, the method comprising:
holding, within a drying chamber, the organic material under controlled atmospheric conditions;
measuring, by sensing equipment, the atmospheric conditions within the drying chamber;
regulating, by convection equipment, temperature and humidity within the drying chamber based on the measured atmospheric conditions; and
regulating, by flow control equipment, flow of one or more gases in and out of the drying chamber based on the measured atmospheric conditions.

12. The method of claim 11, further comprising generating a vacuum in the drying chamber by:
opening a main flow valve of the flow control equipment; and
activating a vacuum generating device to generate the vacuum by removing air, humidity, and/or the one or more gases from the drying chamber through the main flow valve.

13. The method of claim 11, further comprising injecting one or more of the one or more gases into the drying chamber by opening one or more gas valves of the flow control equipment.

14. The method of claim 13, further comprising adjusting a ratio of a gas mixture within the drying chamber, the gas mixture corresponding to a mixture of the one or more gases that preserves one or more properties of the organic material.

15. The method of claim 11, further comprising:
detecting, by a temperature sensor of the sensing equipment, a temperature within the drying chamber;
detecting, by a humidity sensor of the sensing equipment, a humidity level within the drying chamber; and
cycling through one or more activation and deactivation cycles, by the convection equipment, based on the temperature detected by the temperature sensor and the humidity detected by the humidity sensor.

16. The method of claim 15, further comprising:
reducing, by a fan of the convection equipment, the humidity level in the drying chamber in response to the humidity sensor detecting that the humidity level exceeds a threshold humidity level; and
increasing, by a heating device of the convection equipment, the temperature in the drying chamber in response to the temperature sensor detecting that the temperature within the drying chamber is decreased below a threshold temperature level.

17. The method of claim 11, further comprising:
monitoring, by one or more load cells of the sensing equipment, a mass of the organic material held within the drying chamber; and
equalizing, by a purge valve of the flow control equipment, a pressure within the drying chamber with an external pressure in response to the one or more load cells detecting that the mass of the organic material is decreased to a target level.

18. The method of claim 17, wherein the one or more load cells are arranged below a product container configured to hold the organic material within the drying chamber.

19. The method of claim 17, wherein the one or more load cells are arranged above a product container configured to hold the organic material within the drying chamber.

20. The method of claim 11, further comprising:
monitoring, by a moisture sensor of the sensing equipment, a moisture level of the organic material held within the drying chamber; and
equalizing, by a purge valve of the flow control equipment, a pressure within the drying chamber with an external pressure in response to the moisture sensor detecting that the moisture level of the organic material is decreased to a target moisture level.
